(19) United States
(12) Patent Application Publication
(10) Pub. No.: US 2006/0119519 A1
(43) Pub. Date: Jun. 8, 2006

(54) Antenna having radiating part formed flush with surface of casing part

(75) Inventor: Jao-Yong Kwon, Seoul (KR)

Correspondence Address: JONATHAN Y. KANG, ESQ.;LEE, HONG, DEGERMAN, KANG & SCHMADEKA, 14 Floor, 801 S. Figueroa Street, Los Angeles, CA, 90017, US

(73) Assignee: LG Electronics Inc.

(21) Appl. No.: 11/294,722

(22) Filed: Dec. 5, 2005

(30) Foreign Application Priority Data
Dec. 6, 2004 (KR) 10-2004-0101969

(51) Int. Cl. H01Q 1/38; H01Q 1/24

(52) U.S. Cl. 343/700 MS; 343/702

(57) ABSTRACT

Disclosed herein is an antenna having a radiating part formed flush with a surface of a casing part. The antenna includes the radiating part formed in a character pattern and configured to radiate electromagnetic waves; a feeding part formed in a predetermined portion of the character pattern and configured to feed power; a short-circuit part formed adjacent to the feeding part and configured to function as a ground; and a casing part configured to protect internal circuits. The feeding part and the short-circuit part are mounted within the casing part. The radiating part is formed on a surface of the casing part.

Pursuant to 35 U.S.C. § 119(a), this application claims the benefit of earlier filing date and right of priority to Korean Patent Application No. 10-2004-0101969, filed on Dec. 6, 2004, the content of which is hereby incorporated by reference herein in its entirety.

### BACKGROUND OF THE INVENTION

1. Field of the Invention

The present invention relates generally to an antenna having a radiating part formed flush with the surface of a casing.

2. Description of the Related Art

The term “antennae” in Latin means “a feeler of an insect”. Wireless communication is conducted through the air. An antenna is projected into the air surrounding the earth, and radio waves are transmitted and received via the antenna.

An antenna radiates electromagnetic waves from a transmission line to free space and, conversely, receives electromagnetic waves from free space. The antenna may be considered a transformer that performs impedance matching between the transmission line and the free space.

In 1901, Guglielmo Marconi (1874-1937) succeeded in wirelessly transmitting Morse codes across the Atlantic Ocean using electromagnetic waves, by which the antenna became commercially viable. In 1906, with the development of triodes, electronic age began. In 1920, the KDKA radio broadcasting station opened in America, so that One-to-One communication (telegraph and telephone) was developed into One-to-Many communication, and thus the term “broadcast” was coined. Furthermore, TeleVision (TV) was introduced by John Baird in England and Charles Jenkins (1867-1934) in America, and the BBC in England first started periodic TV broadcasting using terrestrial waves in 1936.

Next, with the advent of satellite communication using the satellite called Telstar 1 launched in America in 1962, wireless communication technology dramatically developed, thereby leading to the present mobile communication environment. In particular, the mobile communication market has entered its third generation, and developed from Cellular into PCS and then IMT-2000. With the development of hardware and software for wideband services, the need for small and light antennas has increased, and wideband antennas for the transition to wideband services and multi-band antennas for the transmission and reception of radio waves having a multi-band are issued as essential technology for antennas.

Accordingly, in consideration of trend in communication equipment, which has been lightened and miniaturized, and design aesthetics, the need for an antenna embedded in an apparatus is increasing. Therefore, since 1990, research and development for embedded small antennas have been continuously carried out. In particular, an Inverted F-Antenna (IFA), which includes a ground plane, a radiation or resonator plane, a feeding point and a short, and resonates at a specific frequency due to electromagnetic coupling between the radiation plane and the ground plane, has been focused on. An IFA applied structure is most widely applied to small antenna systems currently. A planer-IFA is most generally used.

However, when such an antenna is embedded, the appearance thereof is beautiful, but reception sensitivity is generally degraded.

### SUMMARY OF THE INVENTION

Accordingly, the present invention has been made keeping in mind the above problems occurring in the prior art, and an object of the present invention is to provide a new type of antenna, which is applicable as the semi-embedded antenna of a small communication apparatus, such as a portable terminal.

Another object of the present invention is to provide an antenna which has a simple structure and is applicable to a small communication apparatus.

In order to accomplish the above object, the present invention provides an antenna having a radiating part formed flush with a surface of a casing part, which includs the radiating part formed in a character pattern and configured to radiate electromagnetic waves; a feeding part formed in a predetermined portion of the character pattern and configured to feed power; a short-circuit part formed adjacent to the feeding part and configured to function as a ground; and a casing part configured to protect internal circuits and in which the feeding part and the short-circuit part are mounted within the casing part and the radiating part is formed on a surface of the casing part.

In the present invention, an auxiliary depression having a shape larger than the pattern of the radiating part is preferably formed on the surface of the casing part.

In the present invention, a protective dielectric for protecting the radiating part from external contact is preferably formed on the radiating part.

In the present invention, the protective dielectric is preferably transparent or opaque.

In the present invention, the radiating part is preferably coated with dielectric material.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating an antenna having a character pattern according to an embodiment of the present invention;

FIG. 2 is a side view illustrating the antenna having a character pattern according to the embodiment of the present invention;

FIG. 3 is a perspective view illustrating an antenna having a character pattern according to another embodiment of the present invention;

FIGS. 4A and 4B are diagrams illustrating the characteristics of the antenna depending on a character pattern of the radiating part;

FIGS. 5A and 5B are diagrams illustrating a method of setting bandwidth and resonance points depending on a character pattern according to another embodiment of the present invention;

FIG. 6 is a diagram illustrating an antenna pattern, part of which is implemented in the form of a slot; and

FIG. 7 is a perspective view illustrating an antenna mounted on the surface of a casing part according to an embodiment of the present invention;

FIG. 8A is a diagram schematically illustrating a state in which the radiating part of the antenna is mounted on the surface of the casing part according to an embodiment of the present invention; and

FIG. 8B is a diagram illustrating a state in which the radiating part of the antenna is mounted on the surface of the casing part according to another embodiment of the present invention.

### DESCRIPTION OF THE PREFERRED EMBODIMENTS

Reference now should be made to the drawings, in which the same reference numerals are used throughout the different drawings to designate the same or similar components.

Generally, an embedded antenna is not externally visible, so that there is an advantage in terms of design, but is considerably influenced by internal parts and various factors because the antenna is located within the mobile device, thereby degrading the antenna characteristics. As a result, the present invention proposes an antenna structure having the electromagnetic characteristics of an external antenna as well as the advantage of an embedded antenna in terms of design.

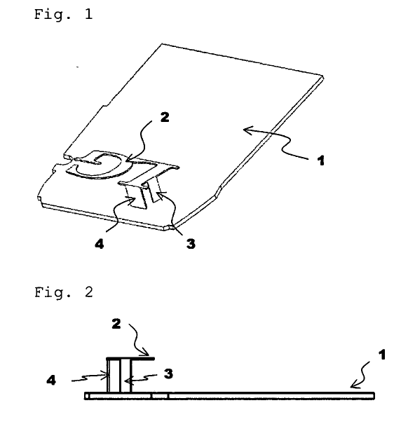

FIGS. 1 to 3 are diagrams illustrating an antenna having a character pattern according to an embodiment of the present invention.

In the present embodiment, the antenna includes a printed circuit board 1, a radiating part 2, a feeding part 3 and a short-circuit part 4.

The present embodiment schematically shows a method of forming the antenna on the printed circuit board 1.

Referring to FIGS. 1 to 3, the radiating part 2 of the antenna can be formed in a combination of alphabets or numerals to have the shape of a known character. The combination includes various combinations, such as a combination of one specific language letter (for example, an English letter), another specific language letter (for example, a Korean letter) and a numeral and a combination of a specific language letter and a specific symbol (for example, a trademark). Particularly, when the combination becomes a word having a specific meaning or a specific firm name (for example, LG, GE or SAMSUNG), the radiating part of the antenna has another meaning, in addition to the functions of a simple radiating part.

The basic length of the antenna is determined depending on the central frequency of the antenna, and the antenna is tuned to have a specific central frequency band and frequency bandwidth by adjusting the shape of the characters and the spaces between the characters, which constitute the radiating part. At this time, the width, length, and spaces of the radiating part 2 of the antenna are the important factors of design, which determine the horizontal and vertical scales, gradient, and letter-spacing of the fonts of the characters that constitute the radiating part 2.

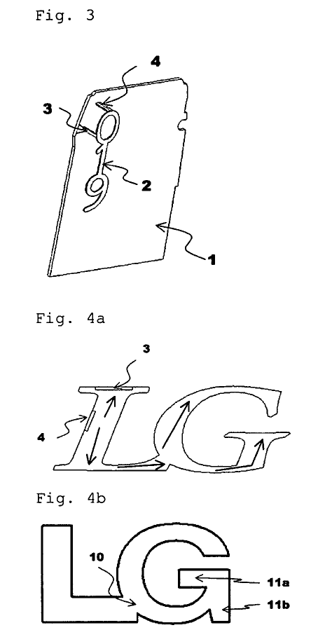

FIGS. 4A and 4B are diagrams illustrating the characteristics of the antenna depending on the character pattern of the radiating part 2.

FIGS. 4A and 4B illustrate the embodiment of the radiating part 2, in which the combination “LG” of letters L and G formed in the radiating part 2 has the antenna characteristics of a specific frequency band and allows it to represent the firm name. In the drawings, respective embodiments have different fonts, horizontal and vertical scales and letter-spacing, so that the meanings of the letters are identical to each other, but the electromagnetic characteristics thereof differ with the radiating parts 2.

In consideration of the operating frequency of the antenna, the positions of the feeding part 3 and the short-circuit part 4 must be determined so as to form a proper current path on the radiating part 2 having the character pattern, as illustrated in FIG. 4A. Since the bandwidth characteristics of the antenna depend on the width and shape of the letter, they must be properly selected depending on the desired antenna characteristics.

That is, single stroke characters, such as L, N, W, S and 7, may affect the operating frequency, and multi-stroke characters, such as G, k, B and 4 may affect the bandwidth characteristics of the antenna, so that desired frequency characteristics can be obtained through the proper combination of character patterns. At this time, the current path may vary depending on the connections between characters, so that the connections between characters are also an important factor to determine the pattern of the antenna according to the present invention. For example, in the character patterns illustrated in FIGS. 4A and 4B, the character “L” mainly functions to obtain the current path for the resonance of the antenna, and the character “G” expands the bandwidth of the antenna by forming two current paths depending on connection position 10. Additional branches of the strokes, such as 11a and 11b, allow the bandwidth to be further expanded.

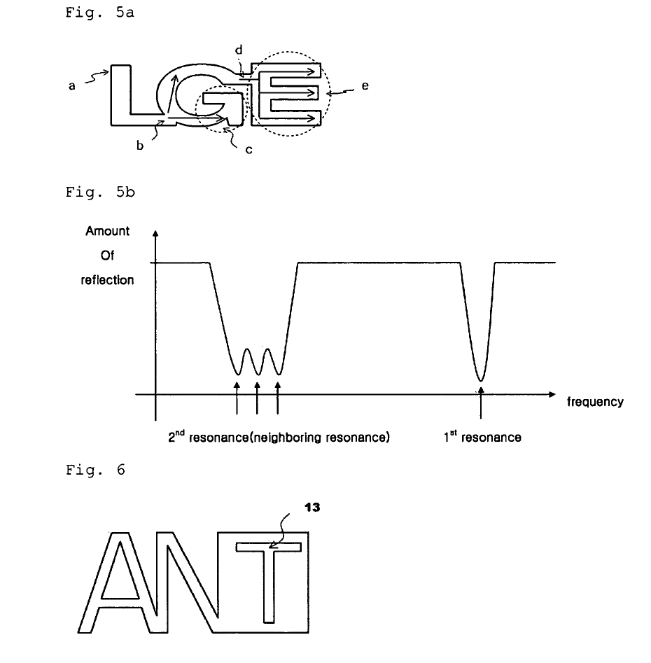

FIGS. 5A and 5B are diagrams illustrating a method of setting bandwidth and resonance points depending on a character pattern according to another embodiment of the present invention.

Existing characters (for example, English alphabet) may be mainly classified into three types depending on their shapes (note: the classification may vary depending on the font, capital letters and upper-case letters). If feeding is performed on the assumption the three types are antenna patterns, electromagnetic characteristics exhibit features depending on the classification as follows.

The first is classification depending on stroke, in which characters are classified into signal stroke and multi-stroke characters.

Single stroke characters include C, I, L, W and Z. When power is fed to one end of a single stroke character, the single stroke character forms single current path, so that the stroke length of the character forms a current path that determines the resonance frequency of the antenna.

Multi-stroke characters include E, F, G, K, H and Y. When power is fed to one end of a multi-stroke character, the current path is divided depending on the shape of the stroke, so that a multiple resonance phenomenon occurs.

The second is classification depending on symmetry, in which characters are classified into vertically or horizentally symmetrical and asymmetrical characters.

The vertically or horizentally symmetrical characters include A, E, H, W and X. When power is fed to one end of a symmetrical character, current paths, which have the same length, can be generated, which provides a desirable resonance feature. Furthermore, when the feeding point deviates somewhat from the axis of symmetry, neighboring multiple resonances are generated, thereby expanding the bandwidth.

The asymmetrical characters include G, K, P, Q and R. The features thereof vary depending on positions of the feeding points, so that the resonance frequency can be adjusted by combination with a single stroke character.

The last is classification depending on a loop structure, in which the classification is made depending on whether the shape of the character has a slot.

A, O, P, Q and R are closed characters. Since the shape of each character has a slot, electromagnetic effects due to the slot, such as the adjustment of the amount of radiation using the length, width or angle of the slots, may be utilized.

FIG. 5B is a graph illustrating frequencies where resonance points are generated by the character patterns of FIG. 5A.

The character pattern of FIG. 5A is described based on the above description. The above embodiment of the antenna pattern has the combination of a single stroke (asymmetrical) character “L”, a multi-stroke character “G” and a multi-stroke and symmetrical character “E” as per the above suggested classification criteria. If the feeding point “a” is located at one side end of “L” as illustrated in FIG. 5A, the single stroke character “L” mainly plays the role of obtaining a current path for resonance as described above. Since the single stroke character “L” is connected to the multi-stroke and asymmetrical character “G” at point “b”, the current path branches, so that portion “c” of the multi-stroke and asymmetrical character forms a first resonance point. A portion of the multi-stroke and asymmetrical character “G” is connected to the multi-stroke and symmetrical character “E” through a connection structure “d”. As described above, the power is fed at the point deviating from the axis of symmetry, so that three different current paths “e” are formed, thereby forming three successive neighboring resonances. As a result, the frequency difference therebetween being very small as illustrated in FIG. 5B, are generated, so that a second resonance point that is wide overall is formed.

FIG. 6 is a diagram illustrating an antenna pattern, part of which is implemented in the form of a slot 13. If necessary, the slot may be implemented as illustrated in FIG. 6.

If necessary, a mounting hole or support (not shown) may be formed in a radiating part for the facilitation of antenna mounting. The radiating part may have a height difference, rather than a uniform height as in a step shape or an inclined shape.

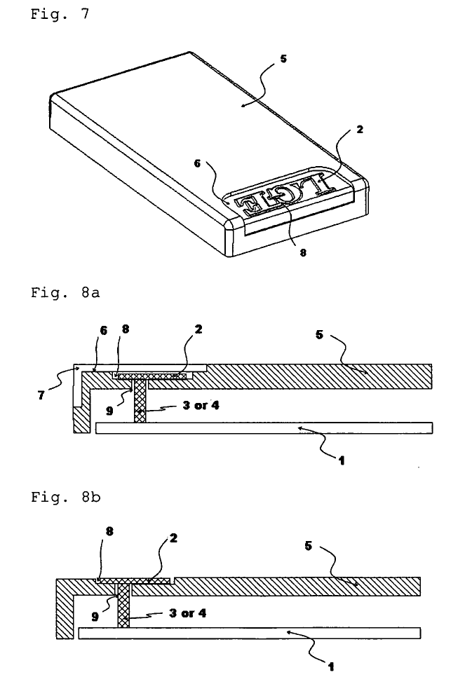

FIG. 7 is a perspective view illustrating an antenna mounted on the surface of a casing part according to an embodiment of the present invention.

FIG. 7 schematically illustrates a state in which the radiating part 2 of the antenna is mounted on the surface 5 of the casing part.

Referring to FIG. 7, the antenna having a structure similar to that of FIG. 1 is flush-mounted on the surface 5 of the casing part. Therefore, the antenna is prevented from protruding outside by mounting the radiating part 2 on the surface 5 of the casing part. The detailed structure thereof is illustrated in FIGS. 8A and 8B.

FIG. 8A is a diagram schematically illustrating a state in which the radiating part of the antenna is mounted on the surface of the casing part according to an embodiment of the present invention.

FIG. 8A schematically illustrates a state in which the radiating part 2 is disposed outside.

Referring to FIG. 8A, the antenna having the same character pattern as that of FIG. 1 is formed. That is, a ground part 3 or a feeding part 4 is formed at a predetermined position, that is, on an upper portion, of a printed circuit board 1, and the radiating part 2, which is formed to have a character pattern representing a predetermined meaning, is formed in an end portion of the ground part 3 or the feeding part 4. In the upper portion of the board 1, a casing part is formed such that a predetermined space is formed inside the board 1. The height of the casing part is preferably the same as that of the ground part 3 or the feeding part 4. The upper surface of the casing part is preferably flush with the horizontal surface of the radiating part. There is a hole 9 in the portion of the upper surface of the casing part, through which the ground part 3 or the feeding part 4 is formed. The ground part 3 or the feeding part 4 passes through the hole 9 toward the outside. Furthermore, an auxiliary depression 8 is formed on the upper surface 5 of the casing part, so that the radiating part having the character pattern is preferably housed in the auxiliary depression 8 on the upper surface 5 of the casing part. The space formed by the auxiliary depression 8 is somewhat larger than the radiating part 2 having the character pattern, thereby allowing the radiating part 2 to be readily accommodated.

The above-described structure does not require an additional separate structure for supporting the antenna. That is, the auxiliary depression 8 for flush-mounting the antenna and the hole 8 for the ground part 3 or the feeding part 4 are formed in the casing part itself, so that it is possible to maintain the height of the radiating part of the antenna constant without any auxiliary structure.

In the structure illustrated in FIG. 8A, the radiating part 2 of the antenna may be soiled by external contact, such as contact with a user's body, so that anti-corrosion processing is preferably performed on the radiating part 2 of the antenna. If possible, finishing processing for aesthetics is preferably performed on the radiating part 2 by plating the radiating part 2 of the antenna with gold, silver, or the like. Furthermore, as described above, in the case where the surface of the radiating part 2 is flush with the surface of the casing part, a short circuit may occur due to external contact. Therefore, the radiating part 2 is preferably coated with dielectrics.

FIG. 8B is a diagram illustrating a state in which the radiating part of the antenna is mounted on the surface of the casing part according to another embodiment of the present invention.

FIG. 8B schematically illustrates a state in which a protective dielectric is laminated on a radiating part 2.

Referring to FIG. 8B, an antenna having the same character pattern as that of FIG. 1 is formed. That is, a ground part 3 or a feeding part 4 is formed at a predetermined position, that is, on an upper portion, of a printed circuit board 1, and the radiating part 2, which is formed to have a character pattern representing a predetermined meaning, is formed in an end portion of the ground part 3 or the feeding part 4. In the upper portion of the board 1, a casing part is formed such that a predetermined space is formed inside the board 1. The height of the casing part is preferably the same as that of the ground part 3 or the feeding part 4. The upper surface of the casing part is preferably flush with the horizontal surface of the radiating part. There is a hole in the portion of the upper surface of the casing part, through which the ground part 3 or the feeding part 4 is formed. The ground part 3 or the feeding part 4 passes through the hole 9 toward the outside.

Unlike the embodiment of FIG. 8A, in the embodiment of FIG. 8B, a 2-step depression is formed. First, a guide depression 6, on which the protective dielectric is coated, is formed in the portion of the upper surface of the casing part in which the antenna is formed. The guide depression 6 is preferably formed to extend across the closest vertical surface as well as the portion of the upper surface thereof in the portion in which the antenna is formed. An auxiliary depression 8 for mounting the radiating part 2 is formed within the guide depression 6. The space formed by the auxiliary depression 8 is somewhat larger than the radiating part 2 having the character pattern, thereby allowing the radiating part 2 to be readily accommodated. When the radiating part 2 is accommodated within the auxiliary depression 8, the protective dielectric 7 is coated on the upper surface of the radiating part 2 to correspond to the guide depression 6.

The protective dielectric 7 protects the antenna from external contact of the antenna, thereby preventing contact with a user's body or conductor. The protective dielectric 7 may be made of plastic material that is transparent so as to show the radiating part 2. If the radiating part 2 must not be shown, the protective dielectric 7 is preferably opaque.

In the embodiment of FIG. 8B, an additional structure for supporting the antenna is not required. That is, the auxiliary depression 8 for flush-mounting the antenna and the hole 8 for the ground part 3 or the feeding part 4 are formed in the casing part itself, so that it is possible to maintain the height of the radiating part of the antenna constant without any auxiliary structure.

Furthermore, material which constitutes the protective dielectric 7 or the portion of the casing part located immediately below the radiating part 2 greatly affects the antenna characteristics, so that the material must be taken into account at the time of design.

As described above, according to the present invention, there is the advantage of simultaneously implementing the antenna performance of an external antenna as well as the aesthetic advantage of an embedded antenna.

Furthermore, the present invention is applicable to all fields in which antennas are utilized, and has the advantage of allowing enabling an antenna to be a design factor as well as to be an element of a communication apparatus.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An antenna having a radiating part formed flush with a surface of a casing part, comprising:
the radiating part formed in a character pattern and configured to radiate electromagnetic waves;
a feeding part formed in a predetermined portion of the character pattern and configured to feed power;
a short-circuit part formed adjacent to the feeding part and configured to function as a ground; and
a casing part configured to protect internal circuits;
wherein the feeding part and the short-circuit part are mounted within the casing part and the radiating part is formed on a surface of the casing part.

2. The antenna as set forth in claim 1, wherein an auxiliary depression having a shape larger than the pattern of the radiating part is formed on the surface of the casing part.

3. The antenna as set forth in claim 2, further comprising a protective dielectric for protecting the radiating part from external contact, the protective dielectric being formed on the radiating part.

4. The antenna as set forth in claim 3, wherein the protective dielectric is transparent.

5. The antenna as set forth in claim 3, wherein the protective dielectric is opaque.

6. The antenna as set forth in claim 2, wherein the radiating part is coated with dielectric material.

7. The antenna as set forth in claim 1, wherein the character pattern is formed by connecting at least two characters.

8. The antenna as set forth in claim 7, further comprising an auxiliary structure between the characters.

9. The antenna as set forth in claim 7, wherein each of the characters is one selected from a group consisting of foreign language letters, Korean language letters, numerals and specific characters.

10. The antenna as set forth in claim 7, wherein each of the one characters is a single stroke character or a multi-stroke character.

11. The antenna as set forth in claim 10, wherein the single stroke character determines a resonant frequency by adjusting a length thereof.

12. The antenna as set forth in claim 10, wherein the multi-stroke character determines bandwidth by adjusting a position at which the character is connected to another character pattern.

13. The antenna as set forth in claim 10, wherein a pattern of the character including the multi-stroke character extends a bandwidth by determining a branch point for an additional stroke of the multi-stroke character.

14. The antenna as set forth in claim 7, wherein each of the characters is a vertically or horizentally symmetrical character.

15. The antenna as set forth in claim 14, wherein the radiating part composed of the symmetrical characters generates multi-resonance depending on a position of the feeding part.

16. The antenna as set forth in claim 7, wherein each of the characters is formed in a bent form.

17. The antenna as set forth in claim 1, wherein each of the characters is formed in a slot form.

18. The antenna as set forth in claim 1, wherein the character pattern of the radiating part has a specific meaning.
